(19) United States
(12) Patent Application Publication
(10) Pub. No.: US 2006/0018990 A1
(43) Pub. Date: Jan. 26, 2006

(54) Injector for equipment for injection moulding of plastic materials

(75) Inventors: Maurizio Bazzo, Oderzo (Treviso) (IT); Peter Dal Bo, Vittorio Veneto (Treviso) (IT)

Correspondence Address: HESLIN ROTHENBERG FARLEY & MESITI PC, 5 COLUMBIA CIRCLE, ALBANY, NY, 12203, US

(73) Assignee: INCOS S.p.A., San Polo di Piave (Treviso) (IT)

(21) Appl. No.: 11/176,408

(22) Filed: Jul. 7, 2005

(30) Foreign Application Priority Data
Jul. 7, 2004 (IT) TO2004A000463

(51) Int. Cl. B29C 45/20

(52) U.S. Cl. 425/549

(57) ABSTRACT

An injector for equipment for injection moulding of plastic materials the cylindrical body of which has a distal axial portion of larger diameter, a proximal axial portion of smaller diameter, and an intermediate adapting portion shaped like a truncated cone made of a single piece with the distal and proximal portions. An electrical heating resistor extends without any interruption within a helical groove of the body of the injector.

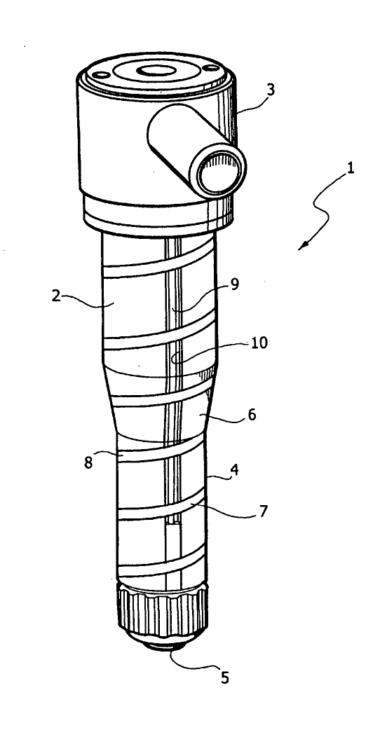

### CROSS REFERENCE TO RELATED APPLICATIONS

This application claims priority from Italian Patent Application No. TO2004A000463 filed on Jul. 7, 2004, the entire disclosure of which is incorporated herein by reference.

### FIELD OF THE INVENTION

The present invention relates in general to equipment for injection moulding of plastic materials, and regards, more in particular, an injector for the introduction under pressure of the fluid plastic material coming from a hot chamber into the cavity of a mould.

### STATE OF THE PRIOR ART

Traditionally, the injector comprises a generally cylindrical body with an axial cavity for passage of the molten plastic material towards a nozzle, and on which electrical resistor means for heating are wound.

In some applications, the geometry of the cavity of the mould is such as to prevent positioning of injectors with a cylindrical body having a generally constant cross section, i.e., having a diameter that is, so to speak, “normal”, given that the corresponding seats provided in the mould would have dimensions that are too large and such as to involve the risk of impairing their mechanical resistance. For this reason, in said applications, it proves necessary to modify the body of the injector by reducing its cross section, i.e., its diameter, in an area corresponding to a proximal axial portion thereof, with reference to its positioning with respect to the cavity of the mould. Said proximal portion, i.e., the one corresponding to the nozzle for outflow of the plastic material, is thus reduced with respect to the distal axial portion of the body of the nozzle, i.e., the one on which the actuator for movement of the injector plug is pre-arranged.

Traditionally, the above reduction is made by providing the distal portion of greater diameter and the proximal portion of smaller diameter as two separate pieces, which are than connected mechanically to one another, for example, by screwing them together. Consequently, the electrical resistor means for heating wound on the body of the nozzle must also necessarily be distinct and include a first resistor wound on the distal portion of greater diameter and a second resistor wound on the proximal portion of smaller diameter, and moreover the use of two distinct control thermocouples, one for each resistor is required.

The above system evidently entails a duplication, in addition to that of the control thermocouples, also of the electrical connections for the injector, with the consequent additional costs deriving therefrom.

### SUMMARY OF THE INVENTION

The purpose of the present invention is to overcome said drawback, and the above purpose is achieved thanks to the fact that an injector for equipment for injection moulding of plastic materials of the type defined in the preamble of claim 1 is mainly characterized in that set between the distal portion and the proximal portion of the body of the injector is an adapting portion shaped like a truncated cone made of a single piece with said distal and terminal proximal portions, and the aforesaid electrical resistor means for heating extend without any interruption from said distal portion to said proximal portion along said adapting portion.

Thanks to the above idea of solution the injector according to the invention, the body of which is evidently made of a single piece, requires a single control thermocouple and a single electrical connection, with evident constructional simplifications and reductions in cost. The body of the injector, as in the case of an injector with a substantially constant cross section, may be formed with a single outer groove having a generally helical shape for housing the single heating resistor so as to obtain, in use, an optimal distribution of temperature throughout the body of the injector. Of course, the helical groove may also be shaped for housing, for purposes of redundancy as in the case of the document No. EP-A-1252998, a pair of resistors set alongside one another, with their corresponding thermocouples, said resistors both extending without any interruption along the distal portion, the intermediate adapting portion, and the proximal portion of the body.

### BRIEF DESCRIPTION OF THE DRAWING

The invention will now be described in detail with reference to the annexed drawing, which is provided purely by of way of non-limiting example, and which is a schematic perspective view of an injector for injection-moulding equipment according to the invention.

### DETAILED DESCRIPTION OF THE INVENTION

In the drawing, the reference number 1 designates the body of an injector according to the invention, the internal conformation of which is generally known and consequently will not be described in detail herein. For the purposes of the present invention, it is sufficient to clarify that the body 1 comprises a generally cylindrical distal portion 2 on which, as in the case of the example illustrated, there can be applied an actuator 3, for example a linear fluid actuator, for actuation of an internal control plug (not illustrated), and a proximal portion 4, which also has a cylindrical shape and is provided with a nozzle terminal part 5 for introduction of the molten plastic material into the cavity of the mould.

The distal portion 2 and proximal portion 4, the axial extension of which may vary according to the requirements of installation of the injector, have a different diameter: the diameter of the distal portion 2 is greater, and that of the proximal portion 4 is smaller. By way of example, the reduction in diameter of the proximal portion 4 may be in the region of 20% of the diameter of the distal portion 2.

The distal portion 2 and proximal portion 4 are connected together by an intermediate adapting portion 6 shaped like a truncated cone, and the three portions 2, 4 and 6 are made of a single piece. In other words, the body 1 consists of a single enbloc assembly.

Designated by 7 is a spiral-shaped, generally helical, groove or slot, made without any interruption on the outer surface of the body 1 along the distal portion 2, the intermediate adapting portion 6, and the proximal portion 4. Set in within the groove 7 is a single electrical heating resistor 8, which thus also extends uninterruptedly over the entire surface of the body 1 through the portions 2, 6 and 4. Operatively associated to the heating resistor 8 is a single control thermocouple 9, which, in the case of the example illustrated, is housed within an outer axial groove 10 of the body 1.

The use of the single resistor 8 and of the single control thermocouple 9 associated thereto is made possible by the enbloc configuration of the body 1, i.e., by the presence of the intermediate portion shaped like a truncated cone 6 formed integrally with the distal portion 2 and proximal portion 4.

As compared to the conventional solutions of injectors having bodies made up of two distinct sections with different diameters connected mechanically together, the invention enables, on the one hand, an appreciable simplification of the process of fabrication of the body, and, on the other, prevention of the need to duplicate heating resistors, the corresponding thermocouples and the corresponding electrical connections.

Of course, the details of construction and the embodiments may vary widely with respect to what is described and illustrated herein, without thereby departing from the scope of the present invention, as defined in the ensuing claims.

Thus, comprised within the scope of the invention is also a solution (not illustrated but conceptually corresponding to the ones described in the document No. EP-A-1252998 cited above), in which the groove 8 houses, instead of a single resistor, a pair of resistors set alongside one another with a redundancy function. In this case, each resistor will be wound uninterruptedly within the groove 8 along the portions 2, 6 and 7 of the body 1 and may be provided with an autonomous control thermocouple.

What is claimed is:

1. An injector for equipment for injection moulding of plastic materials, comprising a generally cylindrical body having a distal axial portion and a proximal axial portion with a nozzle for outflow of the plastic material into a mould, in which said proximal portion has a smaller diameter as compared to that of said distal portion, and in which wound on said body are electrical resistor heating means, wherein set between said distal portion and said proximal portion of said body of the injector is an adapting portion shaped like a truncated cone made of a single piece with said distal and proximal portions, and wherein said electrical resistor heating means extend without any interruption from said distal portion to said proximal portion along said adapting portion.

2. The injector according to claim 1, wherein said electrical resistor heating means include a single resistor with a control thermocouple associated thereto.

3. The injector according to claim 1, wherein said electrical resistor heating means include a pair of resistors independent of one another and set alongside one another, extending without any interruption from said distal portion to said proximal portion along said adapting portion, and a pair of independent control thermocouples associated to said resistors.
